(19) United States
(12) Patent Application Publication
(10) Pub. No.: US 2015/0330397 A1
(43) Pub. Date: Nov. 19, 2015

(54) AIR FLOW DETECTION AND CORRECTION BASED ON AIR FLOW IMPEDANCE

(71) Applicant: International Business Machines Corporation, Armonk, NY (US)

(72) Inventors: Shareef F. Alshinnawi, Apex, NC (US); Gary D. Cudak, Wake Forest, NC (US); Edward S. Suffern, Chapel Hill, NC (US); John M. Weber, Wake Forest, NC (US)

(73) Assignee: International Business Machines Corporation, Armonk, NY (US)

(21) Appl. No.: 14/277,118

(22) Filed: May 14, 2014

(51) Int. Cl. F04D 27/00; G05B 15/02; G05D 7/06; G06F 1/20

(52) U.S. Cl. CPC F04D 27/00; G06F 1/20; G05B 15/02; G05D 7/0617

(57) ABSTRACT

To maintain proper cooling within a computing device enclosure, a computer processor receives input indicating a rotation position of a fan blade of a cooling fan. The computer processor receives input indicating a rotation position of a fan motor magnetic field of the cooling fan. The computer processor calculates a slip of the cooling fan, based on the rotation position of the fan blade relative to the rotation position of the fan motor magnetic field. The computer processor determines an air flow impedance based on the slip of the cooling fan, and in response to a deviation of the air flow impedance from an operational range of air flow impedance, the computer processor increases a rotation speed of the cooling fan, wherein the operational range of the air flow impedance is maintained.

### FIELD OF THE INVENTION

The present invention relates generally to the field of air flow detection, and more particularly to responding to detected changes of airflow in computer enclosures.

### BACKGROUND OF THE INVENTION

Data centers and other computing facilities make use of multiple server computers which are mounted within enclosures designed to hold the servers, and in some cases provide power, cooling, and network connection. Examples of multi-mounted servers include rack-mounted servers which may have a few dozen servers within an enclosure, and blade servers, which may include over one hundred servers within a single enclosure.

As the performance and power consumption of the central processing units (CPUs) of servers continues to increase, the problem of adequately removing heat generated by the CPUs of the servers continues to be a challenge. The most common approach to heat removal in computing systems is the use of airflow, and most server enclosure designs are engineered to deliver sufficient airflow to maintain safe operational temperature levels for the functional components of the server.

Excessive heat buildup within a server enclosure may result in interruption of operations, protective shutdown of the server, or potentially permanent damage to the server CPUs or other components. Excessive airflow wastes energy and increases cost of operation, and may lead to early and unexpected failure of fans providing airflow. Airflow requirements may vary depending on the number and usage of internal components included within a server, as well as the configuration and number of servers within an enclosure that houses multiple servers. Failure to detect changes to air flow removing heat within server enclosures may result in damage to equipment and computing service outage.

### SUMMARY

Embodiments of the present invention disclose a method, computer program product, and system for adjusting an air flow within a computing device enclosure to maintain proper cooling within the enclosure. A computer processor receives input indicating a rotation position of a fan blade of a cooling fan. The computer processor receives input indicating a rotation position of a fan motor magnetic field of the cooling fan. The computer processor calculates a slip of the cooling fan, based, at least in part, on the rotation position of the fan blade relative to the rotation position of the fan motor magnetic field. The computer processor determines an air flow impedance based, at least in part, on the slip of the cooling fan, and in response to a deviation of the air flow impedance from an operational range of air flow impedance, the computer processor adjusts a rotation speed of the cooling fan.

### BRIEF DESCRIPTION OF THE SEVERAL VIEWS OF THE DRAWINGS

FIG. 1 is a functional block diagram illustrating a computer cooling control environment, in accordance with an embodiment of the present invention.

FIG. 2A is an electrical schematic diagram of a photo detection fan blade monitor within a server enclosure fan assembly of FIG. 1, in accordance with an embodiment of the present invention.

FIG. 2B is a block diagram of a motor field detector, used to detect the position of the magnetic field of a fan motor, in accordance with an embodiment of the present invention.

FIG. 2C is an exemplary table depicting the slip determined for the four fans of a multi-server enclosure, depicted in FIG. 1, in accordance with an embodiment of the present invention.

FIG. 2D is an exemplary look-up table including selected time delay measurements between the fan motor magnetic field and the fan rotor, and corresponding slip values and status conditions, in accordance with an embodiment of the present invention.

FIG. 3A is an exemplary graphical display depicting the detection of differences between a fan motor magnetic field and a fan blade during normal fan operation, in accordance with an embodiment of the present invention.

FIG. 3B is an exemplary graphical display depicting the detection of differences between a fan motor magnetic field and a fan blade resulting from air flow leakage, in accordance with an embodiment of the present invention.

FIG. 4 illustrates the operational steps of a cooling control program, inserted on a computing device within the computer cooling environment of FIG. 1, in accordance with an embodiment of the present invention.

FIG. 5 depicts a block diagram of components of a computing device within the computer cooling environment of FIG. 1, capable of executing a cooling control program, in accordance with an illustrative embodiment of the present invention.

### DETAILED DESCRIPTION

Embodiments of the present invention recognize that cooling of server units mounted in server enclosures is essential to prevent overheating that may lead to potential performance and availability issues, and even physical damage of server components. Increases in the number of processors per server and in the power consumption of each processor has increased the need to remove additional heat from the server enclosure. Air flow cooling patterns are developed and engineered for enclosures that house one or more servers, to insure that server environment temperatures are maintained in safe ranges. Air flow patterns are so carefully engineered that changes to internal components or housing structure can significantly alter air flow patterns and result in overheating of servers or server components.

Embodiments of the present invention use measurements of air flow impedance as indicated by the slip of a cooling fan motor, determines the presence of air leakage or air blockage within a server housing, which can produce overheating conditions. Embodiments of the present invention measure fan blade rotation by detecting light passing through a hole in one of the fan blades, and measure the rotation of the magnetic field of the fan motor relative to the rotation of the blade, to determine the slip of the fan. By comparing the calculated slip to a reference table of slip values corresponding to air flow impedance levels and thresholds, the degree of air flow impedance can be determined. Embodiments of the present invention can determine if the air flow is blocked or if there is air flow leakage, and can further determine the area of the server enclosure affecting the air flow impedance. Embodiments respond to a change in air impedance indicating air flow leakage by increasing fan speeds until the air flow impedance returns to a safe range or until a highest sustainable fan speed is attained.

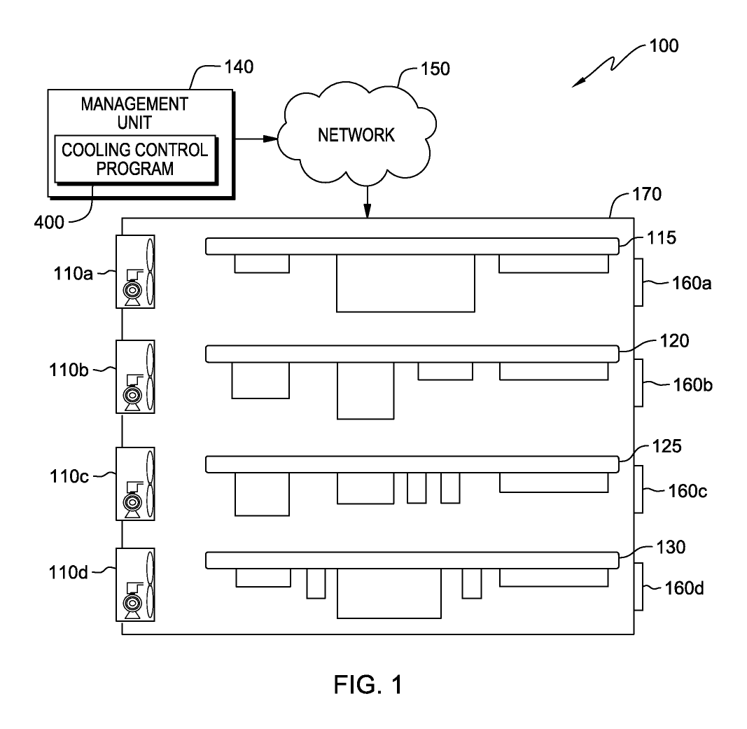

The present invention will now be described in detail with reference to the Figures. FIG. 1 is a functional block diagram illustrating a computer cooling control environment, generally designated 100, in accordance with an embodiment of the present invention. Computer cooling control environment 100 includes multi-server enclosure 170, exhaust ports 160a, 160b, 160c, and 160d, server assemblies 115, 120, 125, and 130, cooling fans 110a, 110b, 110c, and 110d, management unit 140, which includes cooling control program 400, connected to multi-server enclosure 170 via network 150.

Network 150 can be, for example, a local area network (LAN), a wide area network (WAN), such as the Internet, or a combination of the two, and can include wired or wireless connections. Network 150 can be a communication fabric within or between computer processors, such as a PCIe bus. In one embodiment of the present invention, network 150 interconnects management unit 140 and multi-server enclosure 170 using network connections and protocols supporting data transport and communication over a network between computing devices. In general, network 150 can be any combination of connections and protocols that will support communications via various channels between computing devices, within computer cooling control environment 100, in accordance with an embodiment of the present invention.

Multi-server enclosure 170 is a server enclosure that houses one or more servers, and supports server operation by providing cooling, a power supply, and may provide other support controls or services such as network interface support. In one embodiment of the present invention, multi-server enclosure 170 is an enclosure for multiple blade servers, which are mounted vertically, side-by-side, into multi-server enclosure 170 with particular spacing between mounted servers. Each server within multi-server enclosure 170 may be referred to as a “compute node”. The cooling air flow in multi-server enclosure 170 is designed based, at least in part, on all compute nodes being occupied and powered on, and the air flow providing adequate cooling for all servers. In another embodiment, multi-server enclosure 170 is a rack-mount enclosure that may typically house one server and additional components to support the server. It should be understood that various embodiments of the present invention are applicable to server enclosures using cooling fans to dissipate heat, regardless of the number of servers the enclosure is capable of housing. References, hereafter, to multi-server enclosure 170 or to multi-server enclosures in general, include rack mounted server enclosures with a single server as well as enclosures housing multiple servers, and are not limited by the number or configuration of servers contained within the enclosure.

If a compute node position is empty, a blank filler is placed in the empty position, thereby keeping the internal structure of multi-server enclosure 170 consistent. The compute nodes create a level of air flow impedance, which is a resistance to the movement of air, within multi-server enclosure 170 for a given operating speed of the enclosure fans. The air flow impedance is matched and balanced across all the compute nodes within a defined operational range to ensure proper cooling is provided to the individual compute nodes. If there is an opening in the air flow pattern, the air flow will follow a path of least resistance, which alters the balanced cooling air flow to one or more of the compute nodes. As a result, the air flow impedance will be lowered, and one or more of the compute nodes will lack proper cooling and may risk overheating. For this reason, blank fillers are used to occupy otherwise empty server slots in multi-server enclosures, such as multi-server enclosure 170, thus maintaining an air flow impedance at a consistent level that falls within a normal operational range.

Air flow impedance can also be lowered if the multi-server enclosure, such as multi-server enclosure 170, experiences other leakage of cooling air flow. Air flow patterns can be affected if air is exhausted at points other than anticipated exit ports, such as exhaust ports 160a, 160b, 160c, and 160d. If enclosure panels are missing, misassembled, damaged or otherwise allow air flow to escape from multi-server enclosure 170, other than from exhaust ports 160a, 160b, 160c, and 160d, the air flow impedance will be lowered. Depending upon the amount of air impedance loss, one or more compute nodes of multi-server enclosure 170 may lack adequate cooling and may be at risk of overheating.

In other embodiments, multi-server enclosure 170 may experience a blockage of air flow for the cases in which excess or unanticipated hardware is installed or included with installed compute nodes. Air flow blockage may occur for cases in which the balanced air flow within a multi-server enclosure, such as multi-server enclosure 170, is obstructed such that the air flow impedance increases and is greater than the normal operational range.

Exhaust ports 160a, 160b, 160c, and 160d, are designed and designated exit points for air flow within multi-server enclosure device 170. Each of exhaust ports 160a, 160b, 160c, and 160d, are positioned to accommodate exiting air flow of a corresponding fan within multi-server enclosure 170 and maintain a normal operational range of air flow within multi-server enclosure 170.

Servers 115, 120, 125, and 130, each respectively depict a computing device performing server functions and mounted within a server enclosure, such as multi-server enclosure 170. Servers 115, 120, 125, and 130 are depicted in a block diagram top-view as having various components which may be related to the function and performance of the respective server. While in operation, servers 115, 120, 125, and 130 generate heat, which is removed to prevent damage to components, reduction in performance, or reduction of availability of the server. Heat removal is achieved by multiple fans drawing air external to multi-server enclosure 170, and blowing the air in a pattern that contacts the mother boards and components of servers 115, 120, 125, and 130. The air pattern has been designed to remove adequate heat, which is exhausted from multi-server enclosure 170 via exit ports 160a, 160b, 160c, and 160d.

Cooling fans 110a, 110b, 110c, and 110d are included in multi-server enclosure 170 and provide air flow to cool the components installed in multi-server enclosure 170. The speed for each of cooling fans 110a, 110b, 110c, and 110d is independently controlled by management unit 140. Cooling fans 110a, 110b, 110c, and 110d, include a fan rotor blade position detector and a fan motor magnetic field position detector, both of which are used to determine the slip associated with each cooling fan. Management unit 140 receives the information for both the fan blade rotation and fan motor magnetic field rotation, and uses the information to calculate the slip for each cooling fan. The number of fans included in multi-server enclosure 170 is dependent, at least in part, on the air flow volume produced by the fans and the heat removal requirements of installed components. In various embodiments of the present invention, there may be a one-to-one, one-to-many, or many-to-one relationship of fans to installed components. The number of fans and server components depicted in FIG. 1 are for illustrative purposes, and are not meant to suggest or define a specific correspondence between fans and installed components, other than to present an example of fans used to meet the heat removal needs of the enclosure.

Management unit 140 monitors and controls the management of server support items such as power supply, and cooling fan control. Cooling fan control is important to maintain a consistent air flow within a multi-server enclosure, sufficient to remove heat and prevent damage to server components due to overheating. Cooling fan motors that operate using alternating current (AC) produce a rotating magnetic field that rotates at a faster rate than the fan blades attached to the fan rotor. The difference between the rotation speeds is referred to as the “slip” or slippage of the motor. The motor slip increases as the load on a fan motor increases. The load on the fan motor corresponds to the air impedance or air resistance experienced by the operating fan motor. Changes to the air impedance can be determined by measurement of the change of fan motor slippage.

In one embodiment of the present invention, management unit 140 is responsible for setting the fan speed of each fan of a multi-server enclosure based on components installed in the enclosure. A look-up table including information associating the fan speed settings with installed components is used by management unit 140 to adjust the fan speed based on the number and type of installed components in the enclosure. Management unit 140 includes a processor, memory, and connection ports, and provides support for multiple servers within a server enclosure, and may be fully integrated, partially integrated, or completely separate from, a server enclosure, for example. In another embodiment, management unit 140 may be incorporated within a computing device providing one or more support and monitoring functions of installed servers, including cooling fan control integrated within an operating system, or working in conjunction with the operating system.

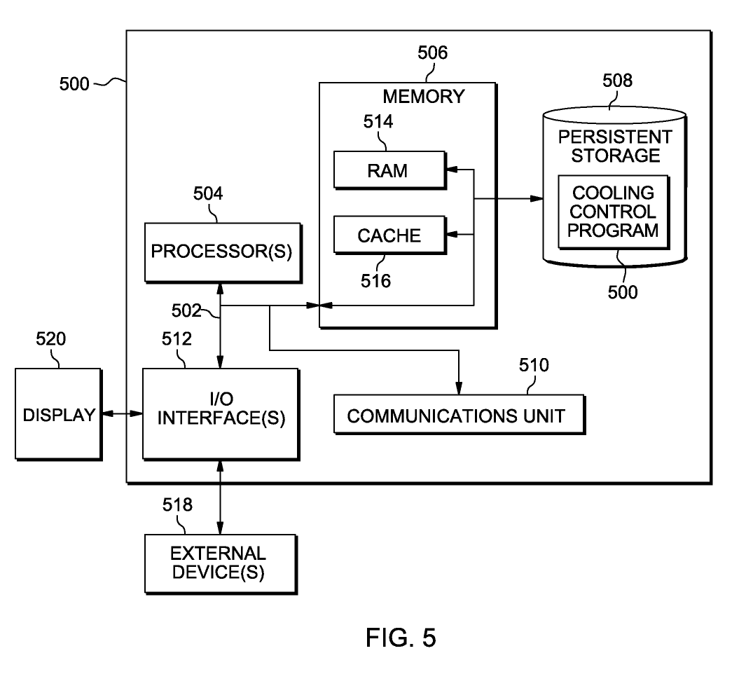

Management unit 140 is a computing device capable of operating cooling control program 400. Management unit 140 can be a laptop computer, tablet computer, netbook computer, personal computer (PC), a desktop computer, a virtual instance of a mainframe computer, a personal digital assistant (PDA), a smart phone, and embedded computing device, or any computing device able to execute machine readable program instructions associated with determining the slippage between a cooling fan blade and the magnetic field of an operating cooling fan, and adjusting the fan speed in response to determining a leakage or blockage of air flow, based on the fan motor slippage determined. Management unit 140 may include internal and external hardware components, as depicted and described in further detail with respect to FIG. 5.

Management unit 140 operates cooling control program 400 and uses slip measurements of the cooling fans to determine if air leakage or blockage conditions exist within a multi-server enclosure, such as multi-server enclosure 170. Cooling control program 400 adjusts fan speed to compensate for changes to air impedance corresponding to changes in fan motor slip. Cooling control program 400 receives the rotation position information of the fan rotor blade and the rotation position information of the fan motor magnetic field, to determine the slip for fans 110a, 110b, 110c, and 110d. Cooling control program 400 uses a comparison of the slip values of fans 110a, 110b, 110c, and 110d, to the respective slip value operational range, to determine if a normal, leakage, or blockage condition of air flow exists for the fan. If the slip associated with a fan is determined to be higher or lower than a normal operating range, cooling control program 400 determines the approximate location of the air flow conditions within multi-server enclosure 170, based on determining the location of the fan associated with the higher or lower slip. Cooling control program 400 determines air flow leakage conditions based on determining a decrease in the slip of a fan deviating from the operational range of air flow impedance, which may indicate, for example, that components of multi-server enclosure 170 are missing, or that some part of the enclosure of multi-server enclosure 170 is compromised. Cooling control program 400 determines air flow blockage based on determining an increase in the slip of a fan deviating from the operational range of air flow impedance, which indicates, for example, that unanticipated components may have been added to multi-server enclosure 170, or components and/or connections are out of place. In one embodiment, cooling control program 400 sends an alert of detected air flow conditions by communicating with an operating system to proactively adjust the clock speed of the central processing unit(s) (CPUs) of affected servers, to reduce exposure to overheating.

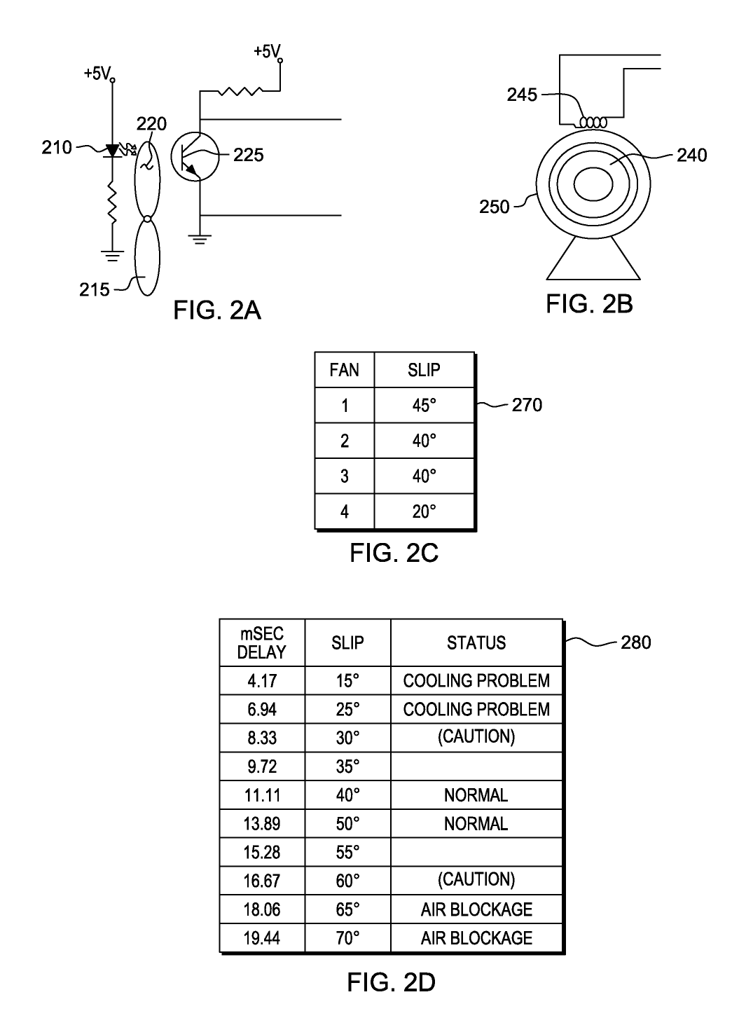

FIG. 2A is an electrical schematic diagram of a photo detection fan blade monitor within a server enclosure fan assembly of FIG. 1, in accordance with an embodiment of the present invention. FIG. 2A includes fan blade 215, fan blade hole 220, photo emitting diode 210, and photo detector 225. Fan blade hole 220 is a hole in one of the multiple blades of the fan, which allows light from photo emitting diode 210 to pass through. The rotating magnetic field of a stator within an AC induction electric motor leads the rotor of the motor, on which is attached fan blade 215. A top-dead-center position of fan blade 215 during rotation is determined by the detection of light from photo emitting diode 210, passing through fan blade hole 220, and detected by photo detector 225. Each rotation of fan blade 215 results in the detection of the position of the fan blade within a rotation, such as top-dead-center. Time of rotations is determined by management unit 140 and in one embodiment, may be used to determine the fan speed in revolutions per minute (RPM).

The difference between the rotation speed of the magnetic field of the motor and the rotation speed of the motor fan blade is referred to as slip. The interaction of currents flowing in the rotor bars and the stators' rotating magnetic field, generates a torque. In actual operation, the rotor speed always lags the magnetic field's speed, allowing the rotor bars to cut magnetic lines of force and produce useful torque, which provides the force for rotor rotation.

FIG. 2B is block diagram of a motor field detector, used to detect the position of the magnetic field of a fan motor, in accordance with an embodiment of the present invention. FIG. 2B includes motor rotor 240, motor magnetic field pickup 245, and motor stator 250. Motor magnetic field pickup 245 detects the rotating magnetic field of the stator as it passes through. In one embodiment of the present invention, positioning motor magnetic field pickup 245 to determine when the rotating magnetic field passes a top-dead-center position enables the calculation of the slip of the rotations of the fan rotor to the magnetic field of the motor. As the motor experiences greater load, the slip value increases, and conversely, as a reduced load is experienced by the motor, slip values decrease. In other embodiments of the present invention, a rotation position other than top-dead-center may be used to determine the motor slip, provided the same reference point of rotation is used for both the fan blade rotation and the magnetic field rotation.

FIG. 2C illustrates a table depicting the slip determined for the four fans of a multi-server enclosure, in accordance with an embodiment of the present invention. FIG. 2C includes table 270, depicting exemplary slip measurements of four fans included in multi-server enclosure, in accordance with an embodiment of the present invention. The slip is represented in degrees of a 360 degree rotation in which the rotor lags behind the magnetic field of the fan motor. Fan 1 is depicted as having a 45 degree slip and both fan 2 and fan 3 are shown as having a 40 degree slip. Fans 1, 2, and 3, may be considered as operating in a normal operational range of slip, with only a small variation. The loads on fans 2 and 3, are relatively similar, which corresponds to the resistance of air flow or air flow impedance encountered by the fans being similar. Fan 1 has a slightly higher air flow impedance than fans 2 and 3; however, fan 4 is shown as having a 20 degree slip, which is significantly less than fans 1, 2, and 3. A lower slip results from lower air flow impedance, which is a reduced load on the motor, and the slip value of fan 4 indicates that there is some form of air flow leakage associated with fan 4. The slip value of fan 4 may be due to missing or unanticipated components in the vicinity of fan 4 that has reduced the air flow impedance, and therefore there is less load on fan 4 resulting in reduced slip.

FIG. 2D includes look-up table 280, illustrating, for example, look-up table information, which includes selected time delay measurements between the fan motor magnetic field and the fan rotor, and corresponding slip values and status conditions, in accordance with an embodiment of the present invention. Look-up table 280 includes time values and slip in degrees associated with a status of the cooling conditions, for various levels of the lag of the fan motor rotor behind the fan magnetic field. In one embodiment of the present invention look-up table 280 is a computer readable data structure, for example a one or more dimensional array, including time delay values of the rotation of the fan motor magnetic field and the corresponding slip in degrees. In one embodiment look-up table 280 is generated by intentionally inducing different air flow impedance conditions within a particular multi-server enclosure and determining the change in rotation speeds or the difference in rotation in degrees between the fan rotor blade and the fan motor magnetic field. The induced air flow impedance is associated with an amount of slip. Conditions which affect slip may include removing a compute node of the multi-server enclosure without replacing the position with a blank filler, removing or blocking air ducts used to balance air flow, varying components within the enclosure, or making adjustments allowing air leakage from the enclosure.

Look-up table 280 illustrates a cooling problem existing at the point in which the detected slip value of a fan has reached 25 degrees or less, which is a significant deviation from a normal slip range of 40 to 50 degrees. Look-up table 280 also illustrates an air flow blockage problem existing when the slip value of a fan is at or exceeds 65 degrees. Look-up table 280 also includes slip values 30 and 35 degrees, in which the slip is below the normal operational range, but not to a threshold point of taking action for a cooling problem due to low air impedance. In one embodiment of the present invention, the slip range of 26 to 30 degrees may be a cautionary or warning range in which cooling control program 400 monitors the slip without taking action, but may provide a warning alert or may ultimately take action if the slip remains within the reduced range for an extended period of time. Similarly a caution range may exist for air flow impedance higher than the normal operational range, such as slip values between 60 and 64 degrees. In other embodiments, caution ranges may be larger or smaller, and action may be taken or ignored.

In one embodiment of the present invention, look-up table 280 is used by cooling control program 400 to determine the type of status condition that exists, based on the detected slip for fans associated with the multi-server enclosure, and to take action based on the threshold slip values included within look-up table 280.

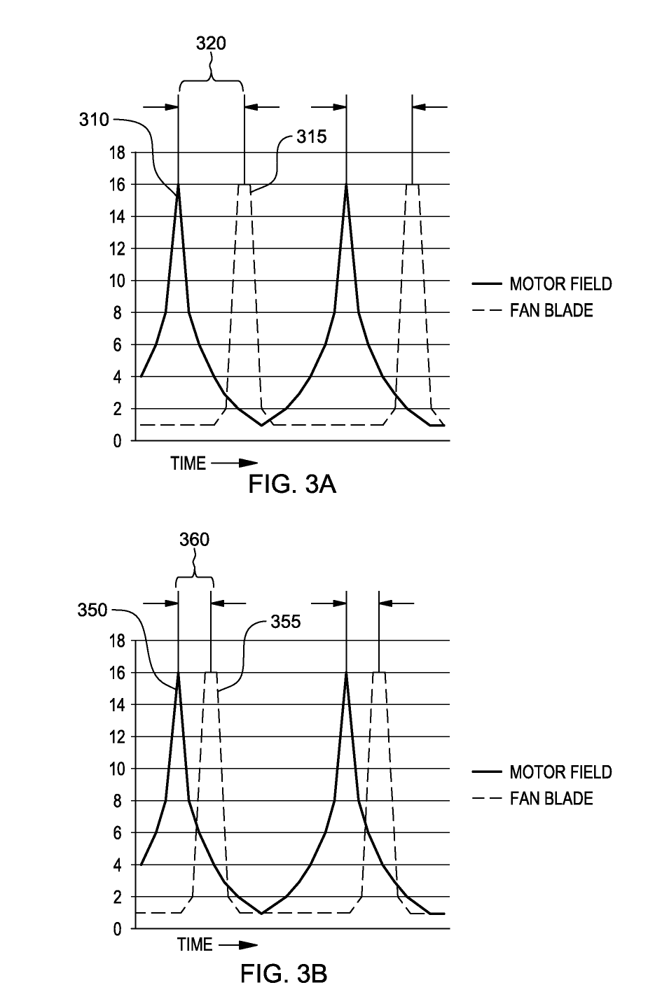

FIG. 3A is an illustrative graphical display depicting the detection of differences of rotation between a fan motor magnetic field and a fan blade during normal fan operation, in accordance with an embodiment of the present invention. FIG. 3A includes peaks corresponding to the detection of motor magnetic field signal 310 and fan blade signal 315 during normal operation with a normal level of air impedance. As depicted in the graphical display, the fan blade rotation lags behind the rotation of the magnetic field of the motor, thus producing torque that provides the force that drives the rotor of the fan blade. The difference between the motor magnetic field and the fan blade is depicted as slip 320. Constant slip corresponds to constant air impedance and constant cooling air flow.

FIG. 3B is an illustrative graphical display depicting the detection of differences between a fan motor magnetic field and a fan blade resulting from air flow leakage, in accordance with an embodiment of the present invention. The graph of FIG. 3B includes peaks corresponding to the detection of motor magnetic field signal 350 and fan blade signal 355 resulting in slip 360. FIG. 3B depicts a reduction of slip 360, as determined by comparison between FIGS. 3A and 3B, which corresponds to a condition of reduced air impedance as compared to slip during normal operation. Reduced air impedance indicates air leakage or disruption of normal air flow in which the air flow follows a path of least resistance, and may result in the lack of adequate cooling air flow in areas of the multi-server enclosure.

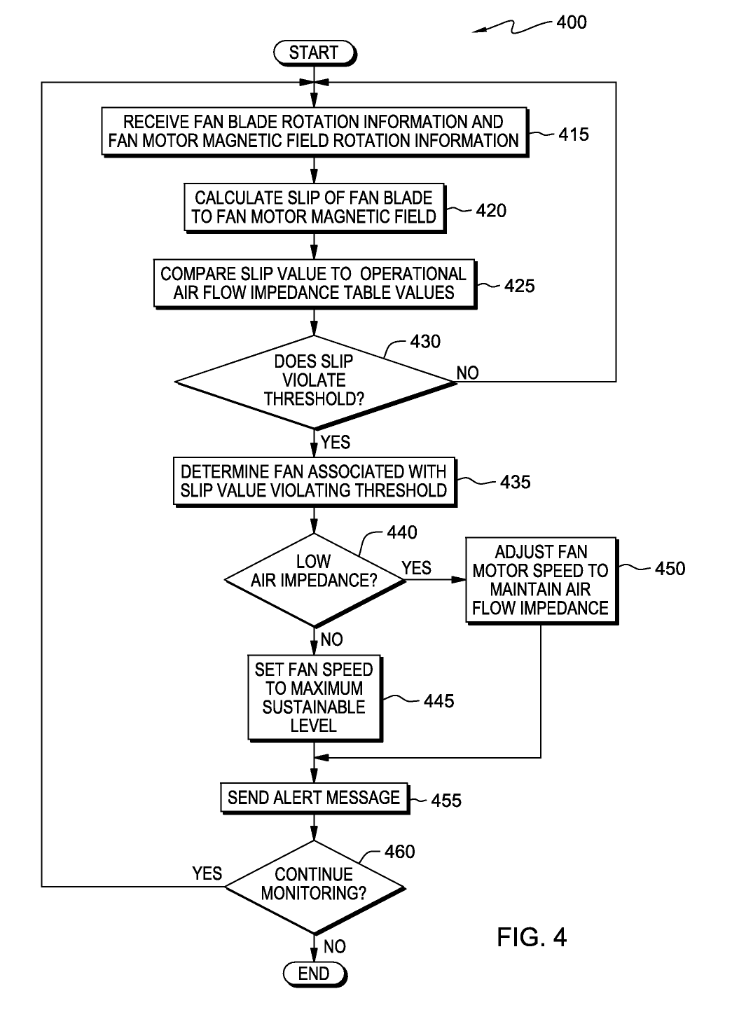

FIG. 4 illustrates the operational steps of cooling control program 400, inserted on a computing device, such as management unit 140, within the computer cooling environment of FIG. 1, in accordance with an embodiment of the present invention. Cooling control program 400 receives fan blade information and fan motor magnetic field rotation information (step 415). The information received by cooling control program 400 includes the fan blade rotation signal and includes the fan motor magnetic field rotation signal. One blade of the rotating cooling fan includes a hole through which light from a photo emitting diode passes when the fan blade otherwise blocks off the light source. The light passing through the fan blade hole contacts a photo detector, which generates a signal from the detected light, and cooling control program 400 receives the signal. A signal is generated by the rotating magnetic field of the motor passing through an inductive sensor and cooling control program 400 receives the rotating magnetic field signal. The difference between the detection of the fan blade attached to the rotor and the magnetic field of the stator, relative to their respective rotation speed or their respective rotation position, determines the slip.

For example, one blade of fan blade 215 includes fan hole 220 which permits light from photo emitting diode 210 to contact photo detector 225 when the one blade of fan blade 215 is at a top-dead-center position. This produces a brief signal that is different than when the other blades of fan blade 215 pass in front of photo emitting diode 210. The signal difference indicates the position of the specific blade with fan blade hole 220 and indicates a revolution of fan blade 215. Motor magnetic field pickup 245 generates a signal when the rotating magnetic field passes through an induction coil pickup, also referred to as a searching coil. The signal indicates that the magnetic field is at a position defined by motor magnetic field pickup 245, which in one embodiment of the present invention, aligns with the same top-dead-center position. The signals and their associated timing and/or frequency, are received by cooling control program 400.

Based on receiving the fan blade and magnetic field rotation information, cooling control program 400 calculates the slip of the fan blade relative to the fan motor magnetic field (step 420). The slip of an electric inductive motor produces torque, which provides the force for rotor rotation. Using the information of the rotation frequency from light signals of a fan blade and the rotation frequency of the magnetic field, cooling control program 400 calculates the difference between the rotations. In one embodiment of the present invention, the slip can be calculated by the time lag of the rotor reaching top-dead-center position of a motor as compared to the magnetic field reaching the same point. In another embodiments, the slip may be calculated as a sector of a 360 degree circle of rotation; the sector representing the lag of the rotor rotation as compared to the magnetic field rotation.

Having calculated the current slip value of a cooling fan, cooling control program 400 compares the slip value to an operational air flow impedance table of values (step 425). The current calculated slip value is compared to slip values that correspond to known air flow impedance values pre-determined to represent air flow impedance levels of normal operation, air flow leakage, and air flow blockage. In one embodiment of the present invention, slip values are determined for air flow impedance of a particular multi-server enclosure containing known components and enclosure conditions. By varying the components, intentionally blocking air flow patterns, removing air ducts, or breeching enclosure housings, slip values are generated that correspond to the known conditions. The slip values associated with known conditions in which air flow impedance levels may result in damage to components of the multi-server enclosure are considered threshold values of known conditions, for example, air flow leakage, air flow pattern change, and air flow blockage.

In one embodiment of the present invention, the slip values and associated conditions are saved, for example in a look-up table stored in memory, and accessible by cooling control program 400. In another embodiment, the slip values associated with known conditions may be stored in a file, a database, or other data structure, accessible to cooling control program 400 or may be directly calculated by cooling control program 400. Cooling control program 400 compares the calculated slip value to the slip values associated with varying conditions in the look-up table.

Having compared the calculated slip value with slip values of the look-up table, cooling control program 400 determines if the slip violates a threshold (decision step 430). Determining that the calculated slip value does not exceed a threshold slip value (step 430, “NO” branch), which may indicate a normal operation air impedance level, cooling control program 400 returns to monitor the slip value of the cooling fan and receive fan blade rotation and fan motor magnetic field rotation information (step 415), and proceeds as described above.

Based on determining that the calculated slip value does violate a threshold, (step 430, “YES” branch), cooling control program 400 determines which fan is associated with a slip value violating a threshold (step 435). Cooling control program 400 receives separate fan blade rotor information and fan magnetic field rotation information for the fans of the multi-server enclosure, and can associate a slip value to a particular fan within an enclosure. For example, cooling control program 400 having receive rotation information for fan blades and fan motor magnetic fields for fans 110a, 110b, 110c, and 110d, determines the slip values respectively depicted as fans 1, 2, 3, and 4, in FIG. 2C. The slip value associated with fan 4 corresponding to fan 110d, indicates a lower air impedance and potential air flow problem associated with fan 110d.

Identification of the fan associated with a slip value that violates a slip threshold, enables cooling control program 400 to provide a location within the multi-server enclosure in which an air impedance problem may be found.

Having identified the fan associated with the calculated slip that violates a threshold, cooling control program determines if the calculated slip indicates a low impedance (step 440). A low air flow impedance will correspond to a slip value that is less than a slip value of the normal operational range. A lower air flow impedance results in air flow moving more easily, taking a path of least resistance, and there may be areas within the multi-server enclosure that no longer receive adequate air flow due to reduced air flow impedance in another area of the enclosure. Determining that the calculated slip value violates a threshold of a low air flow impedance (step 440, “YES” branch), cooling control program 400 adjusts the fan motor speed to maintain air flow impedance (step 450).

By increasing the fan motor speed, cooling control program 400 increases the air flow, and the load on the fan motor increases, which increases the slip. Fan motor speed is increased until the slip value of the fan returns to a range that does not violate a threshold, ensuring that air flow is adequate to remove heat in all areas of the multi-server enclosure. For example, determining that fan 110a has a calculated slip value that violates a threshold associated with a low impedance air flow, cooling control program 400, residing in management unit 140, increases the motor speed of fan 110a until the calculated slip no longer violates the threshold slip value. In another embodiment of the present invention, the fan motor speed, if supported, may be increased by cooling control program 400 until the calculated slip returns to a normal operational level.

Having adjusted the fan motor speed to compensate for reduced air impedance, cooling control program 400 sends an alert message (step 455). Cooling control program 400 produces an alert message that may include the identity of the fan with a slip violating a threshold level, the type of cooling problem indicated by the slip value and may also include the corrective action taken in response to the slip value determined. In one embodiment the alert message may be sent to one or more outputs used to monitor one or more multi-server enclosures, for example, a display monitor, an activity log, or the alert may be used to initiate an alarm. The alert message may be used to initiate additional activity.

In response to sending an alert message, cooling control program 400 determines whether to continue monitoring motor information (decision step 460). Cooling control program 400 continues to monitor the one or more cooling fans of a multi-server enclosure (step 460, “YES” branch), while the servers included in the multi-server enclosure, such as multi-server enclosure 170, continue to operate. While servers within the enclosure continue to operate cooling control program 400 monitors the information associated with the cooling fans of the enclosure. Cooling control program 400 returns to continue receiving fan blade rotation information and fan motor magnetic field rotation information (step 415), and continues as described above, with reference to step 415.

In response to determining that information from the cooling fans will not continue to be monitored, (step 460, “NO” branch) cooling control program 400 ends. Detecting that the servers and components of the multi-server enclosure are to be powered down, such as management unit 140, cooling control program 400 discontinues monitoring of cooling fan information and ends.

Returning to the previous condition of cooling control program 400 determining that the threshold violated is not a low impedance threshold, (step 440, “NO” branch), cooling control program 400 determines that the slip threshold violated indicates an air blockage, and sets the fan speed to a maximum sustainable level (step 445). Determining that the threshold value violated by the calculated slip does not correspond to a low air impedance, cooling control program 400 determines, by reference to pre-determined slip values of a look-up table, for example, the threshold value violated to correspond to a high air flow impedance, which indicates an air blockage within the multi-server enclosure. Because the detected slip corresponding to an air flow impedance is already greater than the normal operation level, the slip will not return to normal operation levels until the air flow blockage is removed.

In one embodiment of the present invention, to provide an increase in cooling air flow to overcome the air flow blockage, cooling control program 400 increases the fan motor speed to a maximum sustainable level, and proceeds to send an alert message (step 455) and continues as described above. In another embodiment, cooling control program 400 may respond to air blockage conditions as indicated by slip values violating a threshold level above the slip values observed under normal operating conditions, by increasing the fan motor speeds of multiple fans, if more than one fan exists within the multi-server enclosure. Additionally, when cooling control program 400 determines slip values indicating an air blockage, alert messages sent may automatically trigger an alarm or include other priority awareness, as unlike the slip values indicating low impedance air flow, slip values indicating high air flow impedance are unable to indicate the amount of improvement received from the increase in fan motor speed. For example, having detected an air blockage, cooling control program 400 generates alert messages and outputs the alert in at least one of the following manners: recording the alert in a message error log, displayed the alert on a screen viewable by an attending user, generating an audio alert, such as an alarm, and generating a visual alert, such as a flashing light.

FIG. 5 depicts a block diagram of components of computing device 500, which is a computing device of computer cooling control environment 100, such as management unit 140, capable of executing cooling control program 400, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 516 and cache memory 514. In general, memory 506 can include any suitable volatile or non-volatile computer readable storage media.

Cooling control program 400 is stored in persistent storage 508 for execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of computer cooling environment 100. In these examples, communications unit 510 includes one or more network interface cards. Communications unit 510 may provide communications through the use of either or both physical and wireless communications links. Cooling control program 400 may be downloaded to persistent storage 508 through communications unit 510.

I/O interface(s) 512 allows for input and output of data with other devices that may be connected to management unit 140. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., cooling control program 400, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for adjusting an air flow within a computing device enclosure, the method comprising:
a processor receiving a rotation position of a fan blade of a cooling fan;
the processor receiving a rotation position of a fan motor magnetic field of the cooling fan;
the processor calculating a slip of the cooling fan, based, at least in part, on the rotation position of the fan blade relative to the rotation position of the fan motor magnetic field;
the processor determining an air flow impedance based, at least in part, on the slip of the cooling fan; and
in response to the air flow impedance deviating from an operational range of air flow impedance, the processor adjusting a rotation speed of the cooling fan.

2. The method of claim 1, wherein a computing device enclosure includes one or more computing devices and includes one or more cooling fans.

3. The method of claim 2, further comprising:
the processor determining a location area within the computing device enclosure, based, at least in part, on the location of a fan of the one or more cooling fans associated with the air flow impedance which deviates from the operational range of air flow impedance.

4. The method of claim 1, further comprising:
the processor determining a leakage of air flow, based on the air flow impedance being less than the operational range of air flow impedance.

5. The method of claim 1, further comprising:
the processor determining a blockage of air flow, based on the air flow impedance being greater than the operational range of air flow impedance.

6. The method of claim 1, further comprising:
in response to determining the air flow impedance deviates from the operational range of air flow impedance, program instructions to generate an alert which includes a type of air flow problem, wherein the type of air flow problem is based, at least in part, on a direction of the air flow impedance deviation from the operational range of air flow impedance.

7. The method of claim 1, wherein the rotation position of the fan blade is determined based, at least in part, on receiving a detection of light passing through a hole in the fan blade and the rotation position of the fan motor magnetic field is determined based, at least in part, on detecting an induction current from a searching coil located within a range of detection of the fan motor magnetic field.

8. A computer program product for adjusting an air flow within a computing device enclosure, the computer program product comprising:
a computer readable storage medium having program instructions embodied therewith, wherein the computer readable storage medium is not a transitory signal per se, the program instructions executable by a processor to cause the processor to perform a method comprising:
receiving, by a processor, a rotation position of a fan blade of a cooling fan;
receiving, by the processor, a rotation position of a fan motor magnetic field of the cooling fan;
calculating, by the processor, a slip of the cooling fan, based, at least in part, on the rotation position of the fan blade relative to the rotation position of the fan motor magnetic field;
determining, by the processor, an air flow impedance based, at least in part, on the slip of the cooling fan; and
in response to the air flow impedance deviating from an operational range of air flow impedance, adjusting, by the processor, a rotation speed of the cooling fan.

9. The computer program product of claim 8, wherein a computing device enclosure includes one or more computing devices and includes one or more cooling fans.

10. The computer program product of claim 9, further comprising:
determining, by the processor, a location area within the computing device enclosure, based, at least in part, on the location of a fan of the one or more cooling fans associated with the air flow impedance which deviates from the operational range of air flow impedance.

11. The computer program product of claim 8, further comprising:
determining, by the processor, a leakage of air flow, based on the air flow impedance being less than the operational range of air flow impedance.

12. The computer program product of claim 8, further comprising:
determining, by the processor, a blockage of air flow, based on the air flow impedance being greater than the operational range of air flow impedance.

13. The computer program product of claim 8, further comprising:
in response to determining the air flow impedance deviates from the operational range of air flow impedance, program instructions to generate an alert which includes a type of air flow problem, wherein the type of air flow problem is based, at least in part, on a direction of the air flow impedance deviation from the operational range of air flow impedance.

14. The computer program product of claim 8, wherein the rotation position of the fan blade is determined based, at least in part, on receiving a detection of light from a hole in the fan blade and the rotation position of the fan motor magnetic field is determined based, at least in part, on an induction current from a searching coil located within a range of detection of the fan motor magnetic field.

15. A computer system for adjusting an air flow within a computing device enclosure, the computer system comprising:
one or more computer processors;
one or more computer readable storage media;
program instructions stored on the computer readable storage media for execution by at least one of the one or more processors, the program instructions comprising:
program instructions to receive a rotation position of a fan blade of a cooling fan;
program instructions to receive a rotation position of a fan motor magnetic field of the cooling fan;
program instructions to calculate a slip of the cooling fan, based, at least in part, on the rotation position of the fan blade relative to the rotation position of the fan motor magnetic field;
program instructions to determine an air flow impedance based, at least in part, on the slip of the cooling fan; and
in response to the air flow impedance deviating from an operational range of air flow impedance, program instructions to adjust a rotation speed of the cooling fan.

16. The computer system of claim 15, further comprising:
program instructions to determine a computing device enclosure, which includes one or more computing devices and includes one or more cooling fans; and
program instructions to determine a location area within the computing device enclosure, based, at least in part, on the location of a fan of the one or more cooling fans associated with the air flow impedance which deviates from the operational range of air flow impedance.

17. The computer system of claim 15, further comprising:
program instructions to determine a leakage of air flow, based on the air flow impedance being less than the operational range of air flow impedance.

18. The computer system of claim 15, further comprising:
program instructions to determine a blockage of air flow, based on the air flow impedance being greater than the operational range of air flow impedance.

19. The computer system of claim 15, further comprising:
in response to determining the air flow impedance deviates from the operational range of air flow impedance, program instructions to generate an alert which includes a type of air flow problem, wherein the type of air flow problem is based, at least in part, on a direction of the air flow impedance deviation from the operational range of air flow impedance.

20. The computer system of claim 15, wherein the rotation position of the fan blade is determined based, at least in part, on receiving a detection of light from a hole in the fan blade and the rotation position of the fan motor magnetic field is determined based, at least in part, on an induction current from a searching coil located within a range of detection of the fan motor magnetic field.
